(19) United States
(12) Patent Application Publication
(10) Pub. No.: US 2012/0153707 A1
(43) Pub. Date: Jun. 21, 2012

(54) VEHICLE TIRE TRACTION DEVICE

(75) Inventors: MEHMET DONDURUR, CROFTON, MD (US); AHMET Z. SAHIN, DHAHRAN (SA)

(73) Assignee: KING FAHD UNIVERSITY OF PETROLEUM AND MINERALS, DHAHRAN (SA)

(21) Appl. No.: 12/974,962

(22) Filed: Dec. 21, 2010

(51) Int. Cl. B60B 15/18; B60C 27/02

(52) U.S. Cl. 301/44.3; 152/213 R

(57) ABSTRACT

The vehicle tire traction device provides additional traction for a vehicle tire when a vehicle is stuck in sand, snow, mud or the like. The vehicle tire traction device includes a flexible sheet having opposed upper and lower surfaces, the lower surface being adapted for covering a portion of a vehicle tire. The upper surface has a tread pattern formed thereon. The flexible sheet has a pair of longitudinally opposed side edges. At least one hook is mounted on each of the side edges for releasably securing the flexible sheet to a wheel. A pair of side flaps are extend from the pair of side edges of the flexible sheet. At least one of the hooks is mounted on each of the side flaps. Each of the hooks is secured thereto by a resilient member, such as a helical spring or the like.

### BACKGROUND OF THE INVENTION

1. Field of the Invention

The present invention relates generally to devices adapted to being mounted on the wheels of a vehicle to improve traction on slippery surfaces and, more particularly, to a vehicle tire traction device that can be installed and removed without raising or moving the vehicle and that can easily be adjusted to fit a variety of sizes of vehicle wheels.

2. Description of the Related Art

Tire traction devices are known. Common tire traction devices, such as tire chains, provide increased traction to a vehicle wheel assembly. When a tire of a wheel assembly provides inadequate traction for a vehicle, a tire traction device may be installed onto the tire by the operator of the vehicle and employed until road conditions improve to the point where the tire traction device becomes unnecessary. Thus, it is important that the tire traction device be simple to install and remove.

Many tire traction devices, when positioned flat on the ground, are ladder-like, having two parallel side chains connected by a plurality of transverse traction chains. The length of the side chains is generally approximately equal to the circumference of the tire, or slightly less, while the length of the traction chains is generally slightly greater than the tire tread width. While various tire traction devices may employ cables or plastic straps in place of chains, the assembly of such tire traction devices is similar to those employing chains.

To install a typical tire traction device, it is first draped over the top of the tire. The length of the traction chains is such that the side chains form a circle concentric with and adjacent to the sidewall of the tire. A tire traction device securing apparatus is then attached to the side chains to remove the slack from the side and traction chains to secure the tire traction device to the tire. Such securing systems often involve complex sets of hooks, loops, cords and the like. For this reason, it is often difficult to install the traction device securing apparatus, especially during inclement weather.

Furthermore, common securing systems provide a single source of tension, often through a single elastic loop. Thus, the conventional securing system will fail to secure the tire traction device to the tire if the elastic loop breaks. Complete failure of the tire traction device securing apparatus may occur at any time with little or no warning. Thus, a vehicle tire traction device solving the aforementioned problems is desired.

### SUMMARY OF THE INVENTION

The vehicle tire traction device provides additional traction for a vehicle tire when a vehicle is stuck in sand, snow, mud or the like, and are not intended for normal driving, but simply to rescue a stuck vehicle. In a first embodiment, the vehicle tire traction device includes a flexible sheet having opposed upper and lower surfaces. The lower surface is adapted for covering a portion of a vehicle tire. The upper surface has a tread pattern formed thereon. The flexible sheet has a pair of longitudinally opposed side edges. At least one hook is mounted on each of the side edges for releasably securing the flexible sheet to a wheel upon which the vehicle tire is mounted. The flexible sheet preferably is substantially rectangular, and a pair of side flaps may be respectively secured to, and extend from, the pair of longitudinally opposed side edges of the flexible sheet. At least one of the hooks is mounted on each of the side flaps. Preferably, each of the hooks is secured thereto by a resilient member, such as a helical spring, an elastic cord or the like.

In an alternative embodiment, the vehicle tire traction device includes an elongated clamping member having a pair of opposed longitudinal edges and having a longitudinal length approximately equal to the diameter of a vehicle tire. A pair of transversely extending, substantially L-shaped arms are respectively secured to the pair of opposed longitudinal edges of the elongated clamping member. Each of the substantially L-shaped arms is adapted for covering and extending across a portion of the vehicle tire, thus securing the elongated clamping member to an exterior surface of the vehicle wheel along a diameter thereof. At least one hook is mounted on a free end of each of the substantially L-shaped arms for releasably securing the elongated clamping member to the wheel upon which the vehicle tire is mounted. As in the previous embodiment, each of the hooks is preferably secured thereto by a resilient member, such as a helical spring, an elastic cord or the like.

In a further alternative embodiment, the vehicle tire traction device includes a relatively thin, substantially U-shaped clamping member having opposed inner and outer surfaces and a pair of free ends. The outer surface is adapted for enhancing traction of the vehicle tire, and the inner surface is adapted for positioning against and gripping the vehicle tire. The U-shaped clamping member is secured to the wheel upon which the vehicle tire is mounted by hooks, a bolt, a pin or the like.

These and other features of the present invention will become readily apparent upon further review of the following specification and drawings.

### BRIEF DESCRIPTION OF THE DRAWINGS

FIG. 1A is an environmental perspective view of a first embodiment of a vehicle tire traction device according to the present invention.

FIG. 1B is a perspective view of the vehicle tire traction device of FIG. 1A, shown being attached to an exemplary vehicle tire.

FIG. 2A is an environmental perspective view of a second embodiment of a vehicle tire traction device according to the present invention.

FIG. 2B is a perspective view of the vehicle tire traction device of FIG. 2A, shown being attached to an exemplary vehicle tire.

FIG. 3A is an environmental perspective view of a third embodiment of a vehicle tire traction device according to the present invention.

FIG. 3B is a perspective view of the vehicle tire traction device of FIG. 3A, shown being attached to an exemplary vehicle tire.

FIG. 4A is an environmental perspective view of a fourth embodiment of a vehicle tire traction device according to the present invention.

FIG. 4B is a perspective view of the vehicle tire traction device of FIG. 4A, shown being attached to an exemplary vehicle tire.

FIG. 5A is an environmental perspective view of a fifth embodiment of a vehicle tire traction device according to the present invention.

FIG. 5B is a perspective view of the vehicle tire traction device of FIG. 5A, shown being attached to an exemplary vehicle tire.

FIG. 6 is an environmental perspective view of a sixth embodiment of a vehicle tire traction device according to the present invention.

FIG. 7 is an environmental perspective view of a seventh embodiment of a vehicle tire traction device according to the present invention.

FIG. 8 is an environmental perspective view of an eighth embodiment of a vehicle tire traction device according to the present invention.

FIG. 9A is a partially exploded environmental perspective view of a ninth embodiment of a vehicle tire traction device according to the present invention.

FIG. 9B is a front environmental view of a tenth embodiment of a vehicle tire traction device according to the present invention.

Similar reference characters denote corresponding features consistently throughout the attached drawings.

### DETAILED DESCRIPTION OF THE PREFERRED EMBODIMENTS

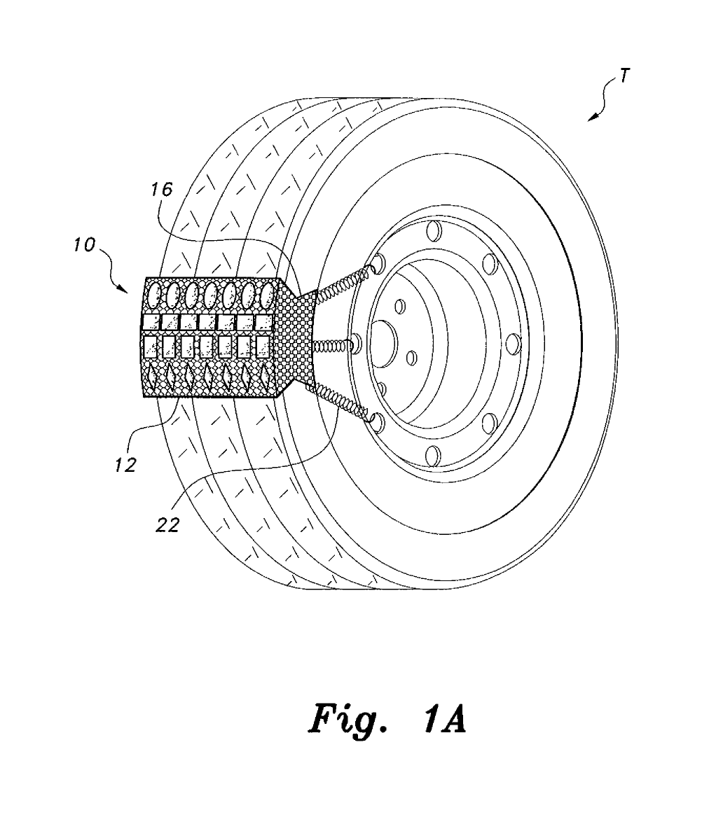

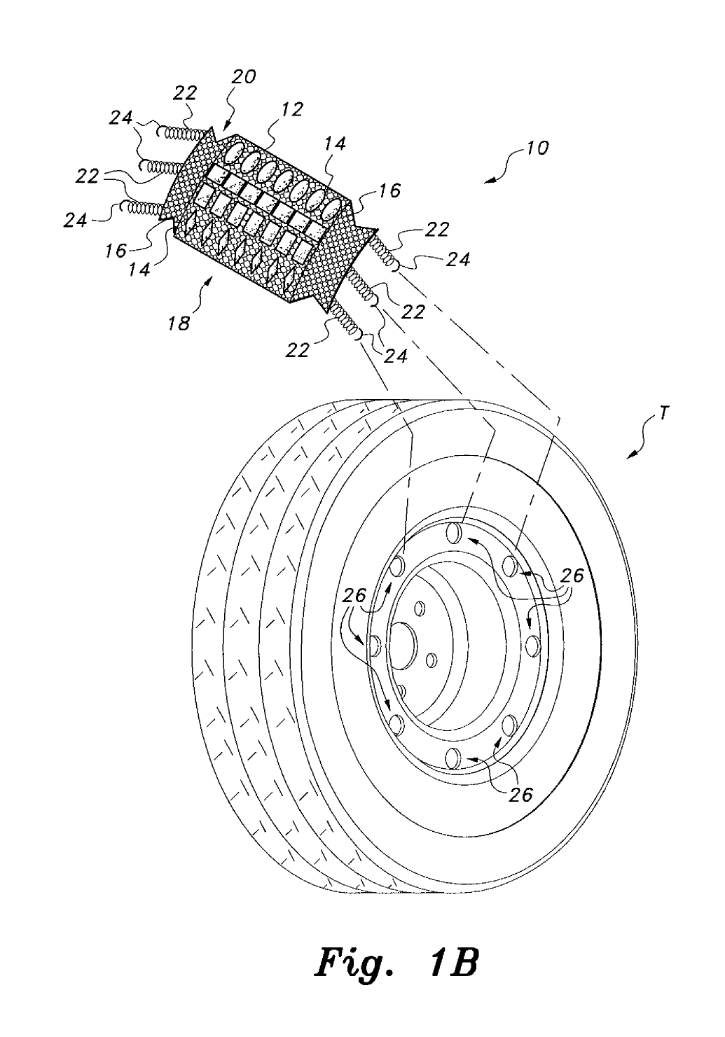

The vehicle tire traction device provides additional traction for a vehicle tire when a vehicle is stuck in sand, snow, mud or the like, and are not intended for normal driving, but simply to rescue a stuck vehicle. The tire will normally be mounted on a drive wheel of the vehicle (front wheels of a front-wheel drive vehicles, rear wheels of a rear-wheel drive vehicle, or either the front or rear wheels of an all-wheel drive vehicle). In a first embodiment, shown in FIGS. 1A and 1B, the vehicle tire traction device 10 includes a flexible sheet 12 having opposed upper and lower surfaces. The lower surface is adapted for covering a portion of the vehicle tire T. The flexible sheet is formed from rubber, flexible plastic or any other suitable material that enhances frictional engagement between the tire T and the driving surface. The flexible sheet 12 preferably only covers a relatively small portion of the outer surface of tire T. The flexible sheet 12 may, for example, have a length (in the orientation of FIG. 1A, the length extends substantially horizontally) of approximately six inches, a width of approximately four inches, and a thickness between approximately one and one and one-half inches. When mounted on the tire T, the wheel will spin on the slippery surface to bring the sheet 12 into frictional engagement with the slippery surface to enhance traction. When the vehicle is back on a drivable, non-skid surface, the device 10 may be removed.

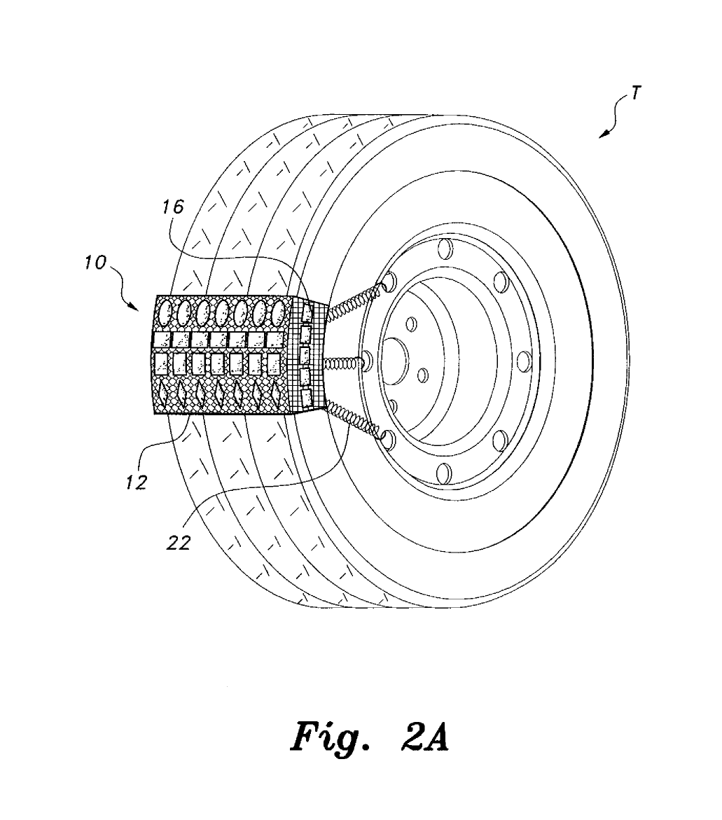

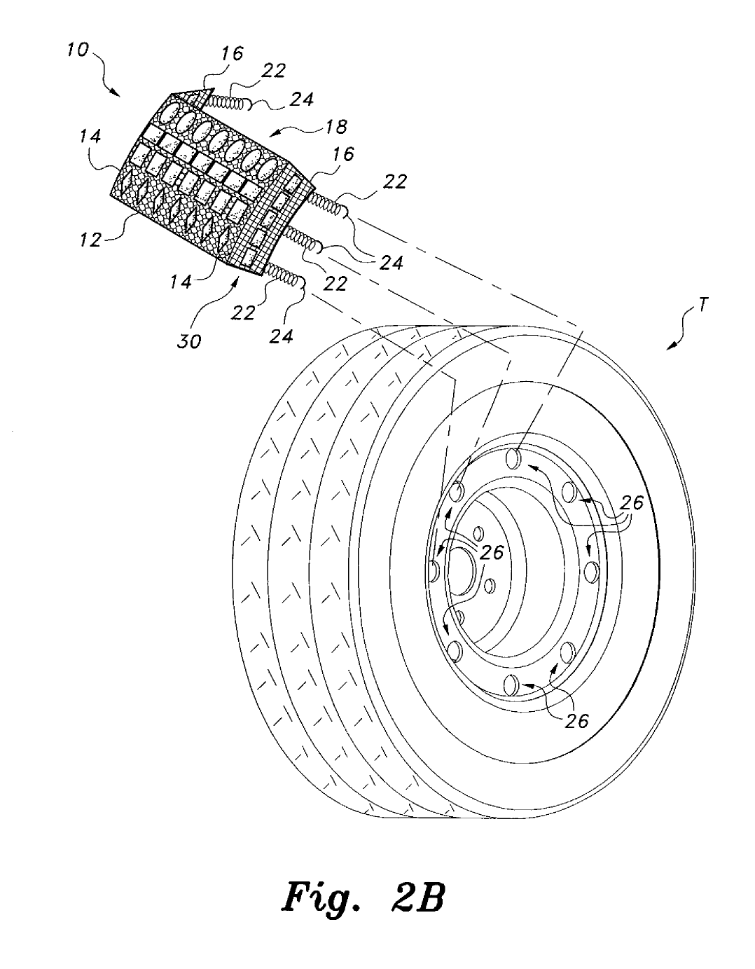

The upper surface has a tread pattern 18 formed thereon. This additional tread 18 preferably has a thickness between approximately one-half and one inches. The flexible sheet 12 has a pair of longitudinally opposed side edges 14. At least one hook 24 is mounted on each of the side edges 14 for releasably securing the flexible sheet 12 to a wheel upon which the vehicle tire T is mounted through holes 26 formed in the periphery of the wheel and opening on both the front and rear faces of the wheel (the holes 26 may be existing ventilation or decorative holes, or the wheel may be specially made with holes 26 for receiving the hooks, and may have a transverse bar, flange, recess, or the like in the hole for the hooks to engage). The flexible sheet 12 preferably is substantially rectangular, and a pair of side flaps 16 may extend from the opposed side edges 14. The hooks 24 are preferably secured to the side flaps by a resilient member 22, such as a helical spring, an elastic cord or the like. In FIGS. 1A and 1B, three such hooks 24, along with corresponding springs 22, are shown secured to each of the side flaps 16. It should be understood that any suitable number of hooks 24 may be used. In FIGS. 1A and 1B, an additional tread pattern 20 is formed on the outer surface of each side flap 16. In FIGS. 1A and 1B, the tread pattern 20 on the side flaps 16 is different and distinct from the tread pattern 18 formed on the flexible sheet 12. However, as shown in FIGS. 2A and 2B, a matching tread pattern 30 may also be formed on the outer surfaces of side flaps 16 so that the tread pattern 30 matches the tread pattern 18.

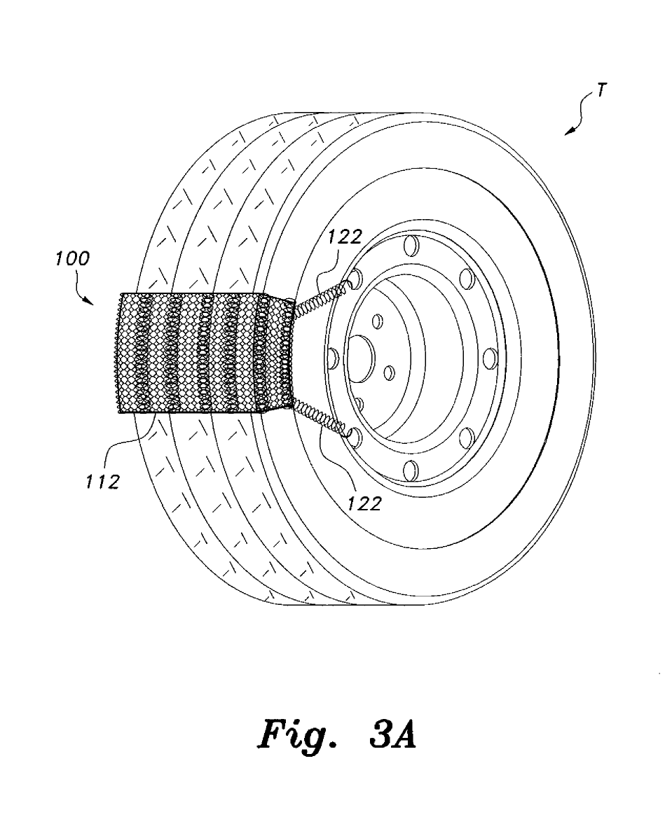

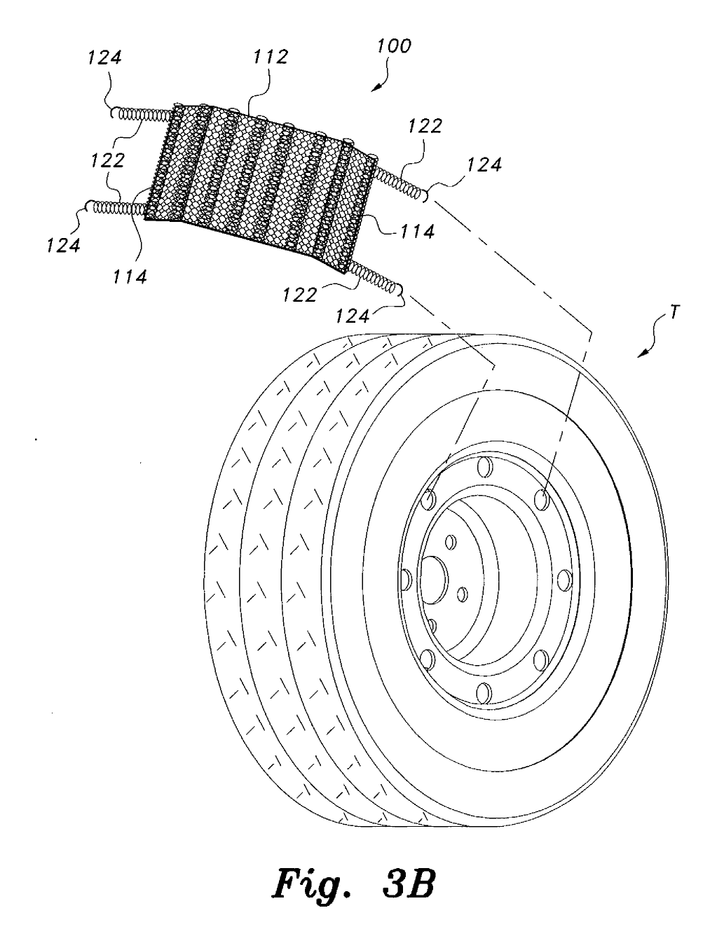

In the alternative embodiment of FIGS. 3A and 3B, the vehicle tire traction device 100 includes a flexible sheet 112 having opposed upper and lower surfaces. The lower surface is adapted for covering a portion of the vehicle tire T. The flexible sheet 112 is formed a metal mesh, such as a wire mesh, a chain mesh or the like. As in the previous embodiments, the flexible sheet 112 preferably only covers a relatively small portion of the outer surface of the tire T. The flexible sheet 12 may, for example, have a length of approximately six inches, a width of approximately four inches, and a thickness between approximately one and one and one-half inches.

The metal mesh forming the flexible sheet 112 forms a traction or tread pattern itself, thus replacing the additional tread 18 of the previous embodiments. The flexible sheet 112 has a pair of longitudinally opposed side edges 114. At least one hook 124 is mounted on each of the side edges 114 for releasably securing the flexible sheet 112 to the wheel upon which the vehicle tire T is mounted through holes 26 formed in the periphery of the wheel and opening on both the front and rear faces of the wheel (the holes 26 may be existing ventilation or decorative holes, or the wheel may be specially made with holes 26 for receiving the hooks, and may have a transverse bar, flange, recess, or the like in the hole for the hooks to engage). The flexible sheet 112 preferably is substantially rectangular. Preferably, each of the hooks 124 is secured to the flexible sheet 112 by a resilient member 122, such as a helical spring, an elastic cord or the like. As opposed to the previous embodiments, the springs 124 are secured directly to the side edges 114; i.e., there are no additional side flaps in the embodiment of FIGS. 3A and 3B. In FIGS. 3A and 3B, two such hooks 124, along with corresponding springs 122, are shown as being secured to each of the side edges 114. It should be understood that any suitable number of hooks 124 may be used.

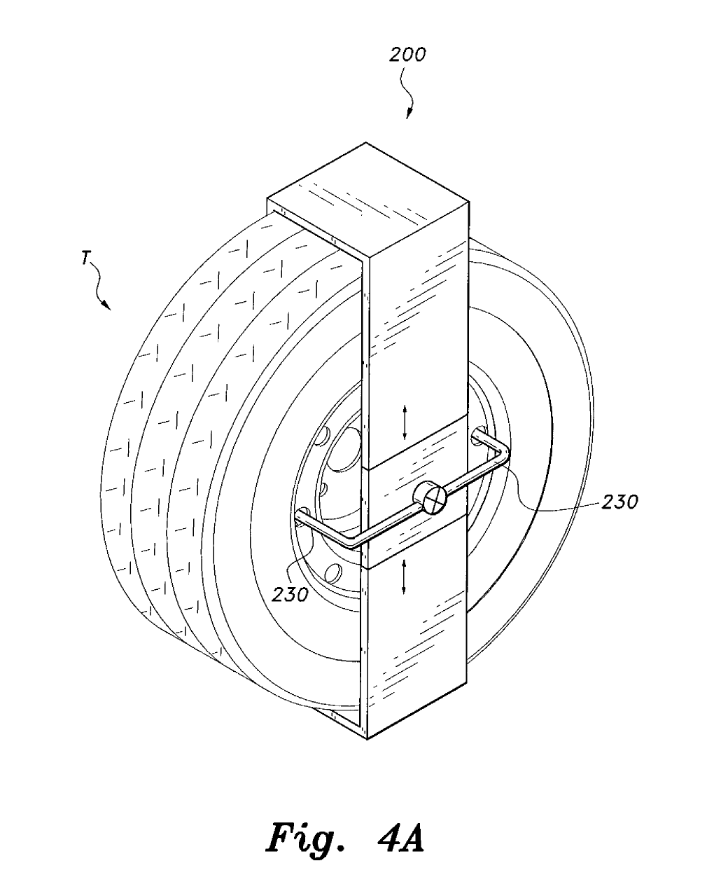

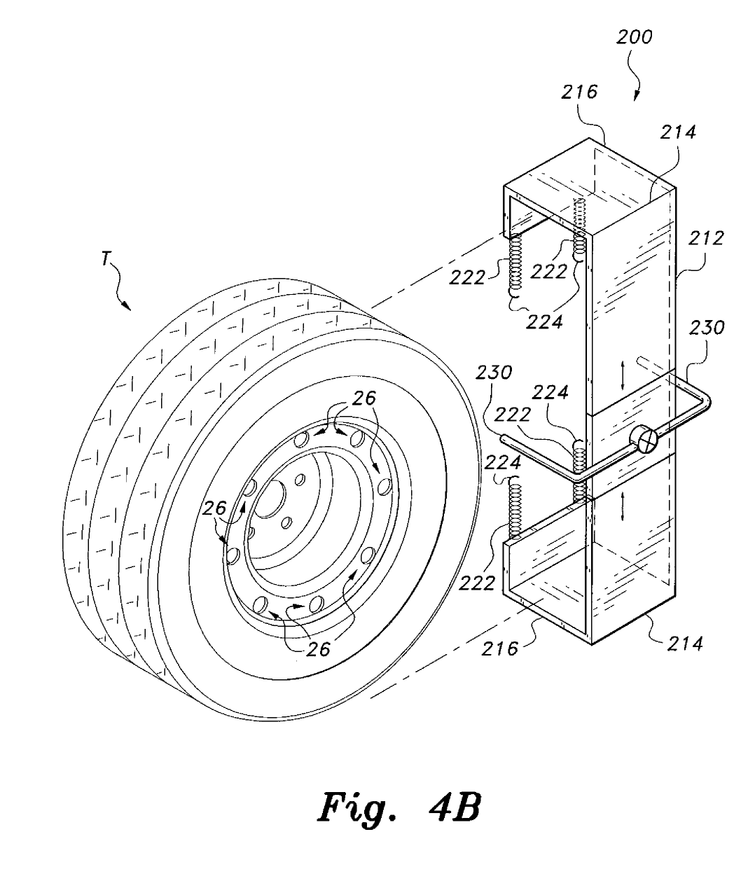

In the further alternative embodiment of FIGS. 4A and 4B, the vehicle tire traction device 200 includes an elongated clamping member 212 having a pair of opposed longitudinal edges 214 and having a longitudinal length approximately equal to the diameter of a vehicle tire T. Clamping member 212 may be formed from any suitable type of metal that will resist corrosion in inclement weather conditions, and may have a longitudinal length, for example, of approximately 24 inches, a lateral width of approximately six inches, and a thickness of approximately one-half of an inch. A pair of transversely extending, substantially L-shaped arms 216 extend from the opposed longitudinal edges 214 of the elongated clamping member 212. Each of the substantially L-shaped arms 216 is adapted for covering and extending across a portion of the vehicle tire T, thus securing the elongated clamping member 212 to an exterior surface of the vehicle wheel along a diameter thereof.

As in the previous embodiments, at least one hook 224 is mounted on a free end of each of the substantially L-shaped arms 216 for releasably securing the elongated clamping member 212 to the wheel upon which the vehicle tire T is mounted. Similarly, each of the hooks 224 is preferably secured thereto by a resilient member 222, such as a helical spring, an elastic cord or the like. In FIGS. 4A and 4B, two such hooks 224, along with corresponding springs 222, are shown as being secured to each of the substantially L-shaped arms 216. It should be understood that any suitable number of hooks 224 may be used. In addition to hooks 224, a pair of laterally extending auxiliary hook members 230 are preferably mounted substantially centrally on the elongated clamping member 212 for releasably securing a central portion thereof to the wheel. Auxiliary hook members 230 may be formed from metal, wire or any other suitable material. The hooks 224 and the auxiliary hook members 230 are attached to the wheel through holes 26 formed in the periphery of the wheel and opening on both the front and rear faces of the wheel (the holes 26 may be existing ventilation or decorative holes, or the wheel may be specially made with holes 26 for receiving the hooks, and may have a transverse bar, flange, recess, or the like in the hole for the hooks to engage).

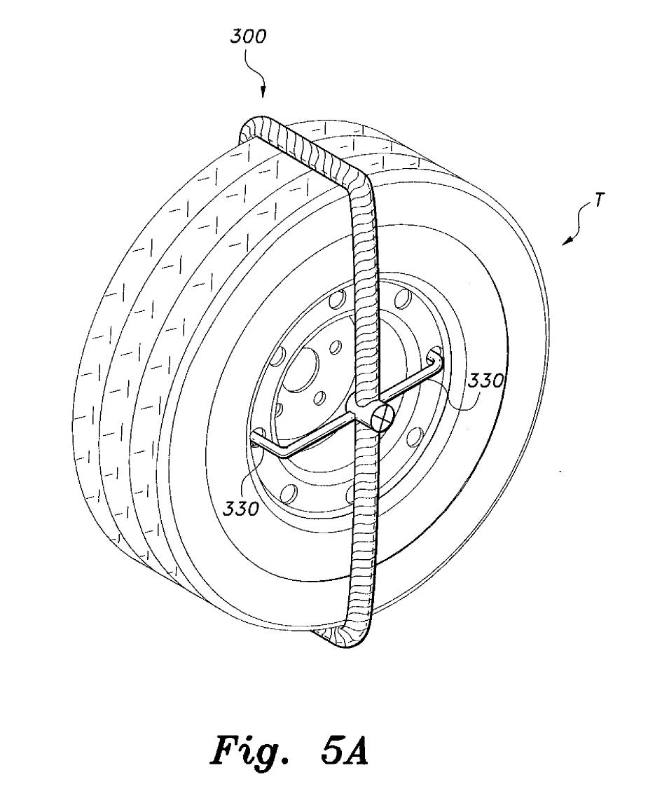

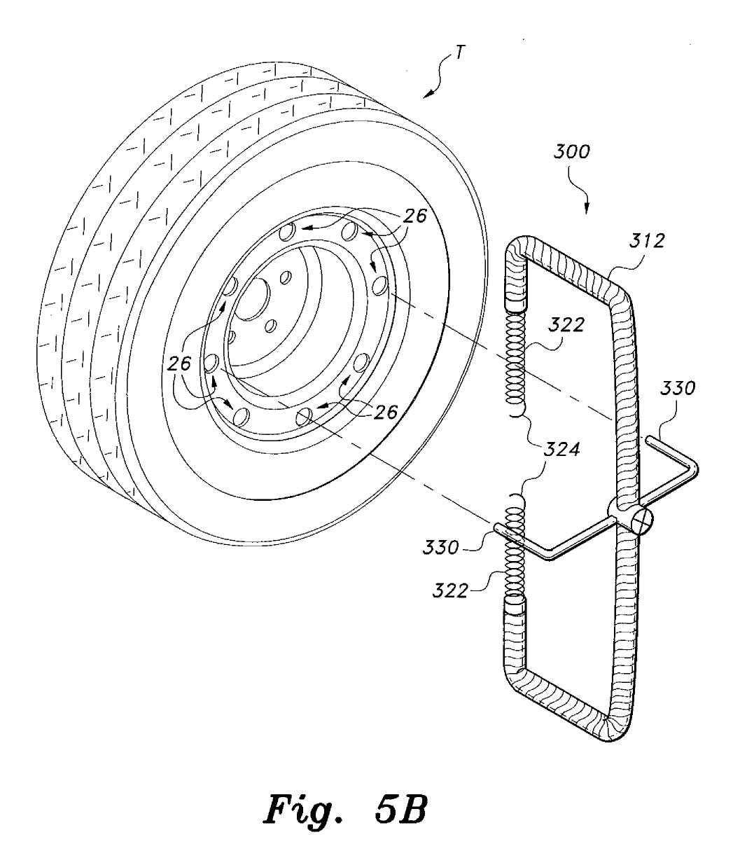

The alternative embodiment of FIGS. 5A and 5B is similar to that shown in FIGS. 4A and 4B. However, the vehicle tire fraction device 300 utilizes a relatively thick length of substantially C-shaped wire 312 to replace the elongated clamping member 212 and the pair of transversely extending, substantially L-shaped arms 216. The substantially straight portion of wire 312 has a length, as in the previous embodiment, of approximately 24 inches, or the diameter of the tire T, and a thickness of approximately two inches.

As in the previous embodiment, at least one hook 324 is mounted on each free end of C-shaped wire 312 for releasable attachment to the wheel upon which the vehicle tire T is mounted. Similarly, each of the hooks 324 is preferably secured thereto by a resilient member 322, such as a helical spring, an elastic cord or the like. In FIGS. 5A and 5B, a single hook 324, along with a corresponding spring 322, is shown being secured to each of the free ends of C-shaped wire 312. It should be understood that any suitable number of hooks 324 may be used. In addition to hooks 324, a pair of laterally extending auxiliary hook members 330 are preferably mounted substantially centrally on the elongated clamping member 312 for releasably securing a central portion thereof to the wheel hub, as shown. Auxiliary hook members 330 may be formed from metal, wire or any other suitable material. The hooks 324 and the auxiliary hook members 330 are attached to the wheel through holes 26 formed in the periphery of the wheel and opening on both the front and rear faces of the wheel (the holes 26 may be existing ventilation or decorative holes, or the wheel may be specially made with holes 26 for receiving the hooks, and may have a transverse bar, flange, recess, or the like in the hole for the hooks to engage).

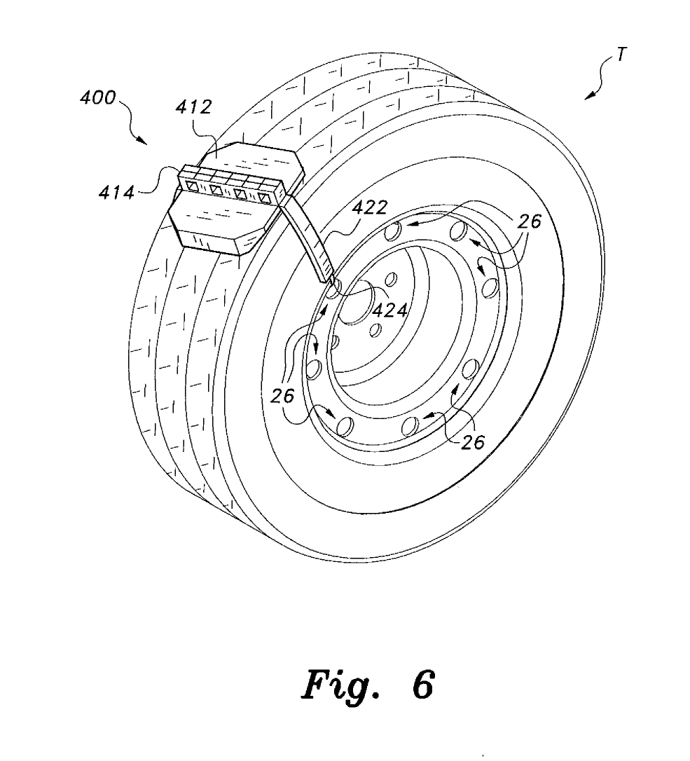

In a further alternative embodiment, shown in FIG. 6, the vehicle tire traction device 400 includes a relatively thin, substantially U-shaped clamping member 422 having opposed inner and outer surfaces and a pair of free ends. A mounting plate 412 is secured substantially centrally on the U-shaped clamping member 422, as shown, with the mounting plate 412 being positioned against the circumferential edge of the tire T. One or more strips of tread or traction material 414 are formed thereon, extending laterally across the outer surface of plate 412, as shown. Although shown as having a substantially octagonal shape, it should be understood that mounting plate 412 may have any desired shape. The mounting plate 412 may have a length (measured along the circumferential or vertical direction, in the orientation of FIG. 6), for example, of approximately six inches, a lateral width of approximately four inches and a thickness of approximately ¼ of an inch.

The free or side ends may be manufactured in a variety of lengths, depending upon the type of vehicle wheel, so that the ends terminate in hooks 424, similar to the hooks of the previous embodiments, which engage the wheel through holes 26 formed in the periphery of the wheel and opening on both the front and rear faces of the wheel (the holes 26 may be existing ventilation or decorative holes, or the wheel may be specially made with holes 26 for receiving the hooks, and may have a transverse bar, flange, recess, or the like in the hole for the hooks to engage). Additional plating may be provided on the lower surface of mounting plate 412 to prevent potential damage to the vehicle tire T.

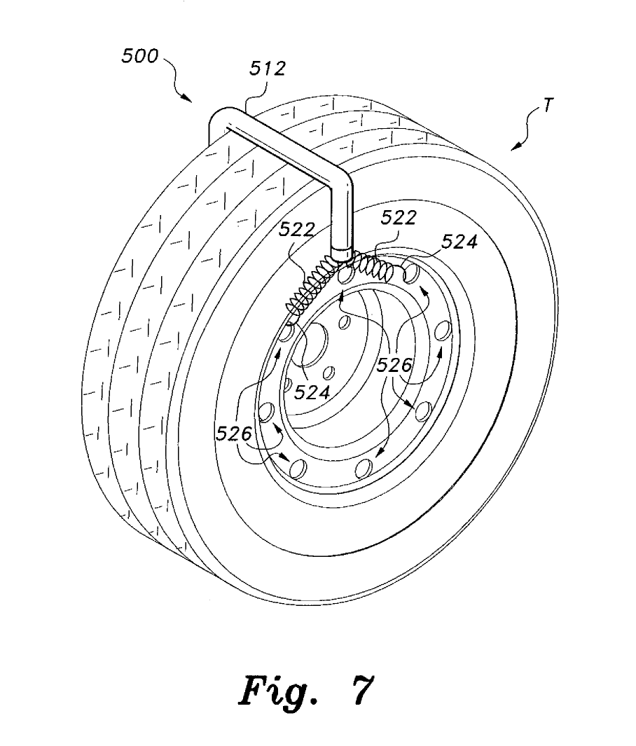

In the additional alternative embodiment of FIG. 7, the vehicle tire traction device 500 includes a relatively thin, substantially U-shaped clamping member 512 having opposed inner and outer surfaces and a pair of free ends. In this embodiment, the mounting plate is removed, and the U-shaped clamping member 512 provides the additional traction itself. Preferably, the U-shaped clamping member 512 is formed from a rigid metal that will not corrode in inclement weather conditions. Preferably, the U-shaped clamping member 512 has relatively sharp edges, and may have a width, for example, of approximately one inch, a thickness of approximately one inch, and an overall length of approximately fifteen to twenty inches, although it should be understood that the U-shaped clamping member 512 may be manufactured in a wide variety of lengths, depending upon the particular style and type of wheel to which it is applied.

The free ends of the U-shaped clamping member 512 terminate in hooks 524, similar to the hooks of the previous embodiments, which engage the wheel through holes 26 formed in the periphery of the wheel and opening on both the front and rear faces of the wheel (the holes 26 may be existing ventilation or decorative holes, or the wheel may be specially made with holes 26 for receiving the hooks, and may have a transverse bar, flange, recess, or the like in the hole for the hooks to engage). As in the previous embodiments, the hooks 524 may be secured to the free ends by resilient members 522, such as springs, elastic cords, or the like.

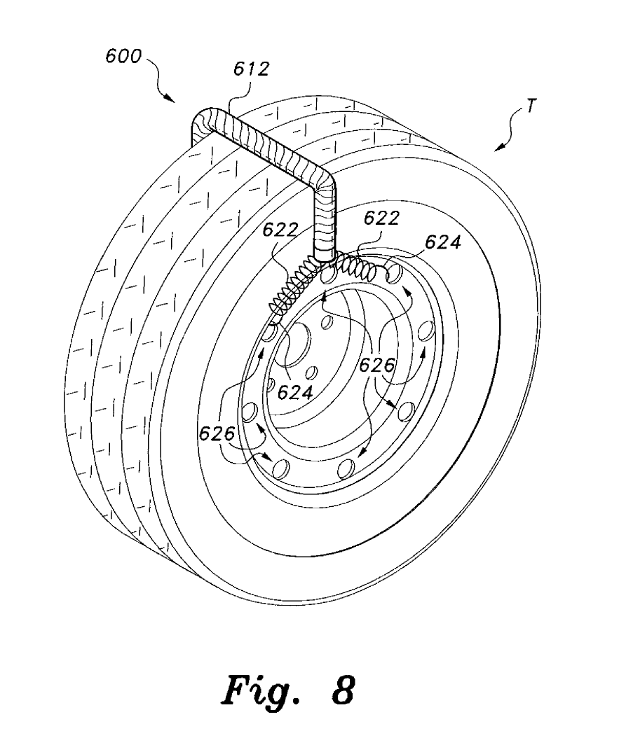

Vehicle tire traction device 600 of FIG. 8 is similar to device 500, but the U-shaped clamping member 512 is replaced with a substantially U-shaped clamping member 612 formed from a circular metal rod. Preferably, the U-shaped clamping member 612 is formed from a rigid metal that will not corrode in inclement weather conditions. The U-shaped clamping member 612 may have a diameter of approximately one to two inches, and an overall length of approximately fifteen to twenty inches, although it should be understood that the U-shaped clamping member 612 may be manufactured in a wide variety of lengths, depending upon the particular style and type of wheel to which it is applied.

The free ends of the U-shaped clamping member 612 terminate in hooks 624, similar to the hooks of the previous embodiments, which engage the wheel through holes 26 formed in the periphery of the wheel and opening on both the front and rear faces of the wheel (the holes 26 may be existing ventilation or decorative holes, or the wheel may be specially made with holes 26 for receiving the hooks, and may have a transverse bar, flange, recess, or the like in the hole for the hooks to engage). As in the previous embodiments, the hooks 624 may be secured to the free ends by resilient members 522, such as springs, elastic cords, or the like. Both devices 500 and 600 are shown with two such hooks and corresponding springs mounted on each free end, although it should be understood that any desired number of hooks may be utilized.

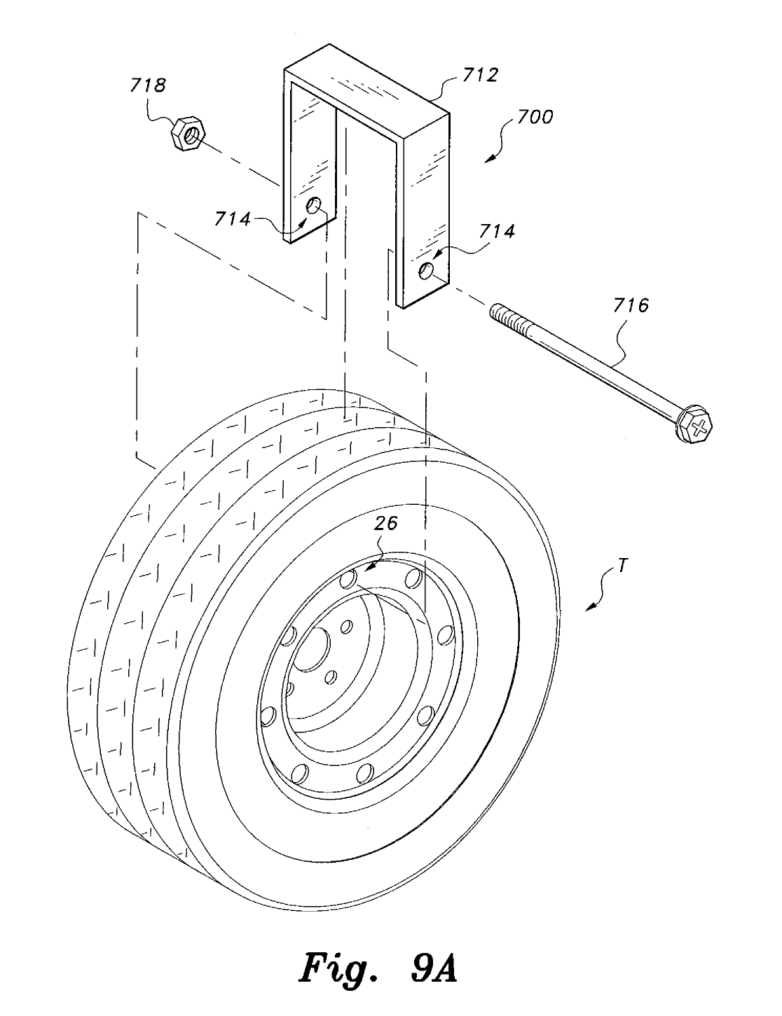

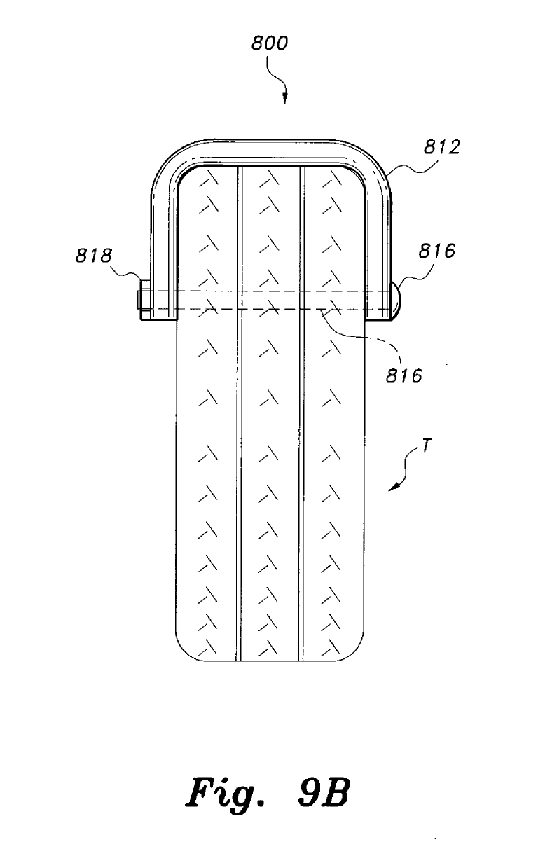

In a further alternative embodiment, shown in FIG. 9A, the vehicle tire traction device 700 includes a substantially U-shaped clamping member 712 having opposed inner and outer surfaces and a pair of free ends. The transversely extending portion of the U-shaped clamping member 712 may have a length of approximately six inches, or a length matching the thickness of the tire T, and a thickness of approximately one-half of an inch. The free or side ends may be manufactured in a variety of lengths, depending upon the type of vehicle wheel, so that the ends align with holes 26 formed in the periphery of the wheel and opening on both the front and rear faces of the wheel (the holes 26 may be existing ventilation or decorative holes, or the wheel may be specially made with holes 26 for receiving a bolt). Each free end has an aperture 714 formed therethrough, as shown, so that a bolt, pin, screw or the like may be inserted through both free ends of member 712 and also through the holes 26 formed through the faces of the wheel. In FIG. 9A, a bolt 716 and corresponding nut 718 are shown, though it should be understood that any suitable member may be used to releasably secure the U-shaped clamping member 712 to the wheel.

Device 800 of FIG. 9B is similar to device 700 described above, but the substantially rectangular bar forming the U-shaped clamping member 712 is replaced by a rounded, or substantially C-shaped, member 812, which is secured to the vehicle wheel by a similar bolt 816 and nut 818, or the like.

It is to be understood that the present invention is not limited to the embodiments described above, but encompasses any and all embodiments within the scope of the following claims.

We claim:

1. A vehicle tire traction device, comprising:
a flexible sheet having opposed upper and lower surfaces, the lower surface being adapted for covering a portion of a vehicle tire, the upper surface having a tread pattern formed thereon, the flexible sheet having a pair of longitudinally opposed side edges; and
at least one hook mounted on each of the side edges of the flexible sheet for releasably securing the flexible sheet to a wheel upon which the vehicle tire is mounted.

2. The vehicle tire traction device as recited in claim 1, wherein said flexible sheet is substantially rectangular.

3. The vehicle tire traction device as recited in claim 2, further comprising a pair of side flaps respectively secured to and extending from the pair of longitudinally opposed side edges of said flexible sheet, at least one of said hooks being mounted on each of the side flaps.

4. The vehicle tire traction device as recited in claim 3, wherein each of the side flaps has opposed inner and outer surfaces, the inner surfaces being adapted for covering a portion of a side surface of the vehicle tire, the outer surface having an auxiliary tread pattern formed thereon.

5. The vehicle tire traction device as recited in claim 4, wherein the tread pattern of the upper surface of said flexible sheet is distinct from the auxiliary tread pattern formed on the outer surface of each said side flap.

6. The vehicle tire traction device as recited in claim 1, further comprising at least one resilient member securing each said hook to each of the side edges of said flexible sheet.

7. The vehicle tire traction device as recited in claim 1, wherein said flexible sheet is formed from rubber.

8. The vehicle tire traction device as recited in claim 1, wherein said flexible sheet is formed from a chain mesh.

9. The vehicle tire traction device according to claim 1, further comprising a wheel, the tire being mounted one the wheel, the wheels having front and rear faces and defining a periphery, the wheel having a plurality of spaced apart holes defined in the periphery of the front and rear faces, the hooks engaging selected pairs of the holes in the front and rear faces to secure said sheet to the wheel in close engagement with the tire.

10. A vehicle tire traction device, comprising:
an elongated clamping member having a pair of opposed longitudinal edges;
a pair of transversely extending, substantially L-shaped arms extending from the opposed longitudinal edges of the elongated clamping member, each of the substantially L-shaped arms being adapted for covering and extending across a portion of a vehicle tire, the clamping member being adapted for extending diametrically across the tire; and
at least one hook mounted on a free end of each of the substantially L-shaped arms for releasably securing the elongated clamping member to a wheel upon which the vehicle tire is mounted.

11. The vehicle tire traction device as recited in claim 10, further comprising a pair of laterally extending auxiliary hook members mounted substantially centrally on said elongated clamping member for releasably securing a central portion thereof to the wheel upon which the vehicle tire is mounted.

12. The vehicle tire traction device as recited in claim 11, wherein said elongated clamping member and each of said substantially L-shaped arms are formed from rigid bars.

13. The vehicle tire traction device as recited in claim 12, further comprising at least one resilient member securing each said hook to each of said substantially L-shaped arms.

14. The vehicle tire traction device as recited in claim 11, wherein said elongated clamping member and each of said substantially L-shaped arms are formed from wire.

15. The vehicle tire traction device as recited in claim 10, further comprising a wheel, the tire being mounted one the wheel, the wheels having front and rear faces and defining a periphery, the wheel having a plurality of spaced apart holes defined in the periphery of the front and rear faces, the hooks engaging holes in the rear face to secure said clamping member to the wheel in close engagement with the tire.

16. A vehicle tire traction device, comprising:
a substantially U-shaped clamping member having opposed inner and outer surfaces and a pair of free ends, the outer surface being adapted for enhancing traction of a vehicle tire, the inner surface being adapted for gripping the vehicle tire; and
means for securing said substantially U-shaped clamping member to a wheel upon which the vehicle tire is mounted.

17. The vehicle tire traction device as recited in claim 16, wherein said means for securing said substantially U-shaped clamping member to the vehicle tire comprise at least one hook mounted on each of the free ends.

18. The vehicle tire traction device as recited in claim 17, further comprising at least one resilient member securing the at least one hook to each of the free ends.

19. The vehicle tire traction device as recited in claim 16, wherein said means for securing said substantially U-shaped clamping member to the vehicle tire comprises a bolt adapted for removable passage through a hole formed through the wheel and through the free ends of the clamping member.

20. The vehicle tire traction device as recited in claim 19, wherein said substantially U-shaped clamping member has a central transversely-extending member and a pair of side arms extending therefrom, each of said side arms being adapted for radial positioning with respect to the vehicle tire when the U-shaped clamping member is mounted thereon.
